(19) United States
(12) Patent Application Publication
(10) Pub. No.: US 2008/0260484 A1
(43) Pub. Date: Oct. 23, 2008

(54) Milling headstock for rivet stems

(76) Inventors: Benito Grille Sacaluga, Cadiz (ES); Fernando Torres Pineda, Cadiz (ES)

Correspondence Address: WENDEROTH, LIND & PONACK, L.L.P., 2033 K STREET N. W., SUITE 800, WASHINGTON, DC, 20006-1021, US

(21) Appl. No.: 12/073,516

(22) Filed: Mar. 6, 2008

(30) Foreign Application Priority Data
Apr. 20, 2007 (ES) P200701064

(51) Int. Cl. B23C 1/12

(52) U.S. Cl. 409/218

(57) ABSTRACT

A milling headstock for rivet stems includes a mouth for the introduction of the stem. A milling machine can be displaced towards the mouth by a previously established length, in order to trim the stem of the different rivets made in a piece. The mouth has a dimension equal to or less than the head of the rivet so that, after introducing the stem via the mouth, the latter at all times rests on the surface of the head of that rivet in such manner that the milling machine is then displaced through the previously established length.

### OBJECT OF THE INVENTION

The invention consists of a headstock intended to carry out trimming of the surplus stem remaining in a rivet once it has been fixed, in order to prevent the surplus stem from being able to emerge with respect to the surface on which the rivet has been attached; and which has the aim of carrying out the trimming at all times leaving the same length of stem in each rivet produced, in such a way that it stays within the margins of tolerance that are established independently of the depth at which each rivet has been fixed in a piece, for which the invention takes the actual head of the rivet as its reference for trimming depth.

The invention is applicable in any sector of the industry in which it is required to carry out trimming of the surplus stem of different rivets made in a piece, and more specifically the invention is applicable to the aeronautical industry for attaching the lining of aircraft, such that the rivets remain within the aerodynamic tolerance, independently of the depth at which each rivet has been fixed in the piece.

### PRIOR ART OF THE INVENTION

In the aeronautical industry, in order to attach the lining of aircraft, the application of blind rivets is known which, once secured, have a surplus stem projecting with respect to their head and which has to be eliminated by means of trimming which is done with a milling machine.

This operation is carried out manually with a machine provided with a mouth into which the surplus stem is introduced, and which includes a milling machine that can be displaced towards the mouth by a previously established length in order to perform the trimming of the different surplus stems of the rivets made on a piece.

Consequently, the trimming is performed by locating the mouth in the zone of the surface of the piece where the rivet is to be found, such that the mouth rests on the surface of the piece, in order to then displace the milling machine by the previously established length, with which said previously established length of displacement of the milling machine causes the trimming to be done to a different depth in each of the rivets made in the piece, since each one of them is located at a different depth in the piece. This means that if the rivet is been fastened high, even though the trimming has been done within the aerodynamic tolerance, the head of the rivet could be damaged due to being higher with respect to the surface and due to the fact that the trimming is carried out for the established length at the same depth of trimming the stem for all the rivets.

On the contrary, if the rivet has been left at a lower depth, the surface of the lining could be damaged.

Consequently, manual milling can cause damage to the lining or to the head of the rivet, or the stem can fail to lie within the aerodynamic tolerance, which means that the trimming has to be done again.

In addition, this process is slow since it is done manually, which increases the cost of the pieces obtained. Also, these manual machines are very costly and of poor quality.

### DESCRIPTION OF THE INVENTION

In order to achieve the objectives and solve the drawbacks stated above, the invention has developed a new milling headstock for rivet stems which, as in the state of the art, comprises a mouth for the introduction of the stem, and which includes a milling machine that can be displaced towards the mouth by a previously established length, in order to trim the stem of the different rivets made in a piece; and it presents the novelty that the mouth has a dimension equal to or less than the head of the rivet so that, after introducing the stem via the mouth, the latter at all times rests on the surface of the head of that rivet in such manner that the milling machine is then displaced through the previously established length. This means that, with the mouth at all times resting on the surface of the rivet head, the trimming is performed in such a way that the same amount of stem is left in each rivet made, keeping them within the established margins of tolerance independently of the depth at which each rivet was attached in the piece.

Consequently, by means of the inventive headstock, the reference for its trimming is at all times done with respect to the surface of the rivet head which means that the depth of the trimming is the same for all the stems of each of the rivets made in the piece.

In a preferred embodiment of the invention, provision has been made so that the milling machine is arranged in a fixed position inside the headstock, while the mouth is provided in an outer casing that can be displaced with respect to the milling machine and is assisted by at least one spring so that when the mouth is pressed against the surface of the rivet head, overcoming the action of the spring, the displacement takes place of the casing towards the rear part of the headstock, and consequently the milling machine advances towards the mouth.

In a preferred embodiment of the invention, the headstock is mounted on a robot of an assembly chain by means of which the rivets are produced, in such manner that the robot then carries out the trimming of the surplus stems of the rivets it has produce. For this purpose the robot is provided with the appropriate means of positioning the headstock facing the head of a rivet and with means of advance so that it presses against that rivet head, with the advance of the milling machine being carried out in the manner that was already described when the robot pushed the headstock against the surface of the rivet head.

The previously established length through which the milling machine is displaced with respect to the mouth is determined by the incorporation of at least one micro-switch which is provided in the support for the milling machine, and which makes contact with a limit related to the casing, at which moment the robot detects the activation of the micro-switch and carries out the withdrawal of the headstock, with the casing returning to its initial position due to the action of the spring and the headstock remaining ready for effecting the milling of the following rivet.

The relative position of the limit with respect to the micro-switch can be adjusted according to the length of the surplus stem, in order to permit the headstock to be adapted to the different riveting robots.

This arrangement has the great advantage that, as the head of the rivet is always used as a reference for the trimming, rather than the surface on which the riveting has been performed, as occurs in the state of the art, this guarantees that neither the rivet nor the surface on which it is made will be damaged, with a trimming being obtained that at all times lies within the established tolerance.

Moreover, this arrangement provides a considerable increase in the efficiency of the operation since it is carried out automatically by the robot, which entails a notable saving in time, and in the event of it being applied for carrying the lining of an aeronautical piece, the aeronautical continuity of it is guaranteed. It also guarantees the repeatability of the trimming with +/−0.01 mm controlled by the micro-switch.

The invention provides a more economical tool since it can be fitted to a robot using the means that the latter has for effecting the said trimming.

The invention also provides an absence of vibrations and an increase in the quality and life of the tool.

Below, in order to facilitate a better understanding of this specification and forming an integral part thereof, a series of figures are attached in which, on an illustrative rather than limiting basis, the most characteristic details of the inventive object have been represented.

### BRIEF DESCRIPTION OF THE FIGURES

FIG. 1. Shows a schematic view of manual trimming done with a conventional machine for the case in which the head of the rivet is located below the level of the surface of the piece in which that rivet has been made.

FIG. 2. Shows a view equivalent to that of the previous figure, but in this case for an example of embodiment of the inventive milling in which the milling machine is in the position for starting the trimming.

FIG. 3. Shows the headstock of FIG. 2 in two different trimming positions, an intermediate position and the final trimming position.

FIG. 4. Shows the headstock of FIGS. 2 and 3, but in this case the head of the rivet is located above the level of the surface where that rivet has been made, unlike in said FIGS. 2 and 3 where the head is located below the level of the surface where the rivet has been made.

### PREFERRED FORM OF EMBODIMENT

Given below is a description of the invention based on the figures commented upon above.

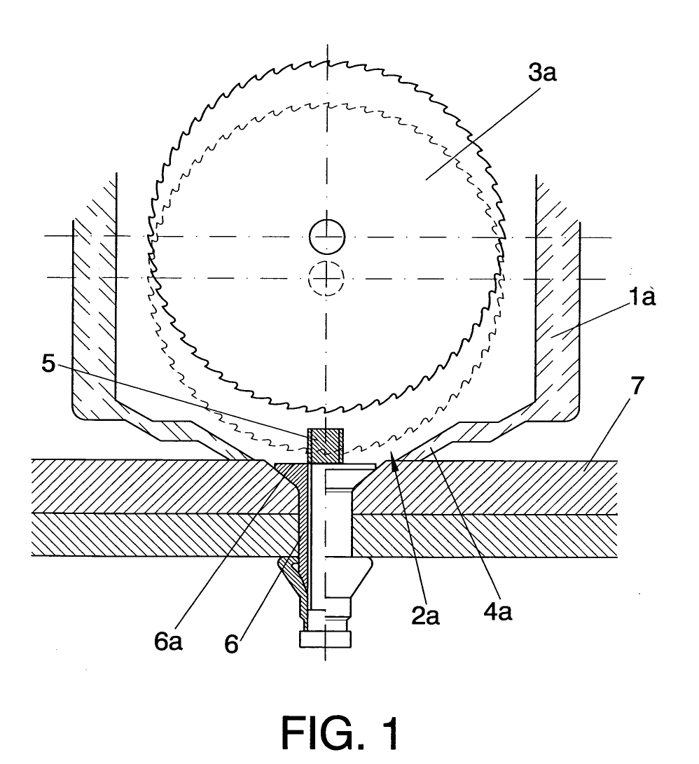

First of all, an example of embodiment is described for a conventional, manually operated, headstock, which comprises a headstock 1 provided with a mouth 4 which defines a central hole 2 via which the surplus stem 5 of the rivet 6 is introduced, in such manner that the trimming milling machine 3 is then made to descend by a previously established length. This length is always the same for each one of the rivets included in the surface 7 of the piece, such that in this case, when the surface of the head 6a finds itself inserted to a depth below the level of the surface 7, the situation shown in FIG. 1 occurs, in which there remains a surplus part of the stem 5. In this case, the stem 5 would not be trimmed within the margins of tolerance, which means that the trimming would have to be done again so that the stem can fall within the established margins. At this point too, it is also possible that if the descent of the milling machine takes place to a greater degree, it could damage the surface 7.

On the other hand, if the surface 6a of the head of the rivet 6 remains above the level of the surface 7, the situation can occur in which that surface 6a becomes damaged.

All this is due to the fact that the mouth 4 rests on the surface 7 of the piece, with which the reference for the displacement of the milling machine 3 is taken with respect to the surface 7, which can cause the damage mentioned above.

In order to solve the stated drawbacks, the invention comprises a casing 1 endowed with a central hole 2 which defines a mouth 4 having dimensions slightly less than those of the surface 6a of the head of the rivet 6.

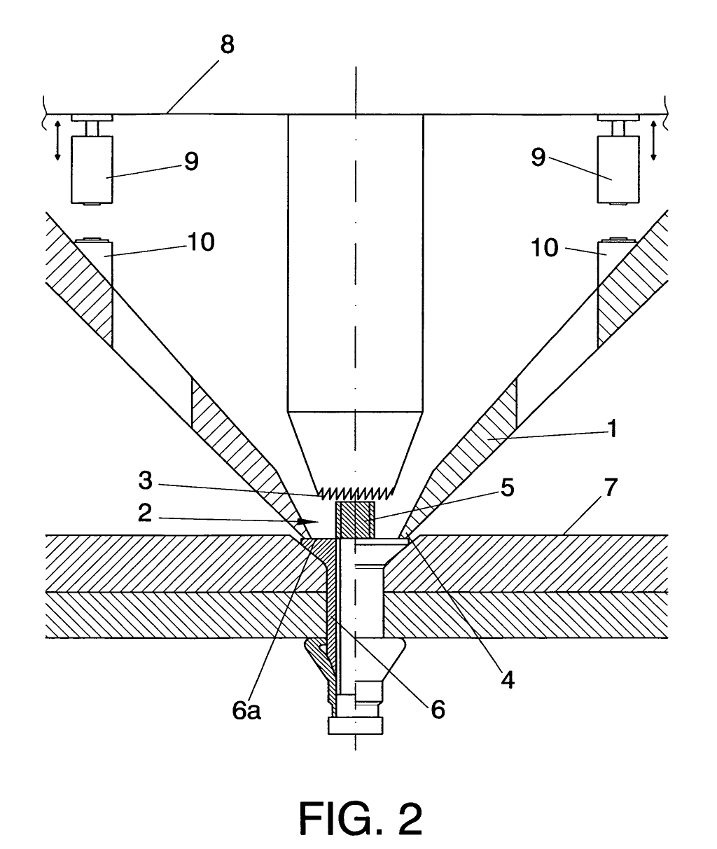

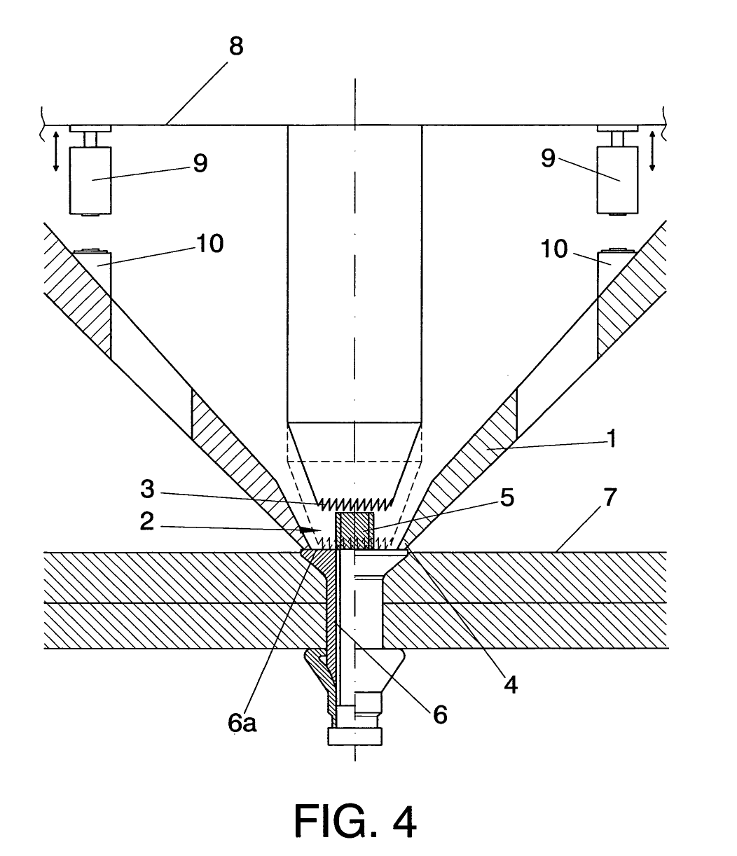

In the preferred embodiment of the invention, the headstock is mounted on a robot (not represented), which includes means for positioning the headstock facing the surface 6a of the head of the rivet 6, as shown in FIGS. 2 to 4. Consequently, in the case of the inventive headstock, the mouth 4 is always going to rest on the surface 6a of the head of the rivet 6, so that said surface 6a is going to constitute the reference for effecting the displacement of the milling machine 3. As a result, the invention does not take the surface 7 as reference, as was described for the state of the art.

The milling machine 3 is arranged on a support 8 in which two micro-switches 9 are supported located in correspondence with separate limits 10 provided in the casing 1, which is assisted by some springs (not represented) in order to permit its displacement with respect to the milling machine 3 when the mouth 4 presses against the surface 6a of the head of the rivet 6.

On the basis of the explanation given it can be easily understood that once the mouth 4 rests on the surface 6a of the head of the rivet 6, the robot continues to carry out the displacement of the headstock with which the casing 1, overcoming the action of the said springs, provokes the relative downward displacement of the support 8 and milling machine 3 with respect to the casing 1, when the casing 1 is displaced in the upward direction with respect to the support 8 due to the action of the pressure exerted by the robot.

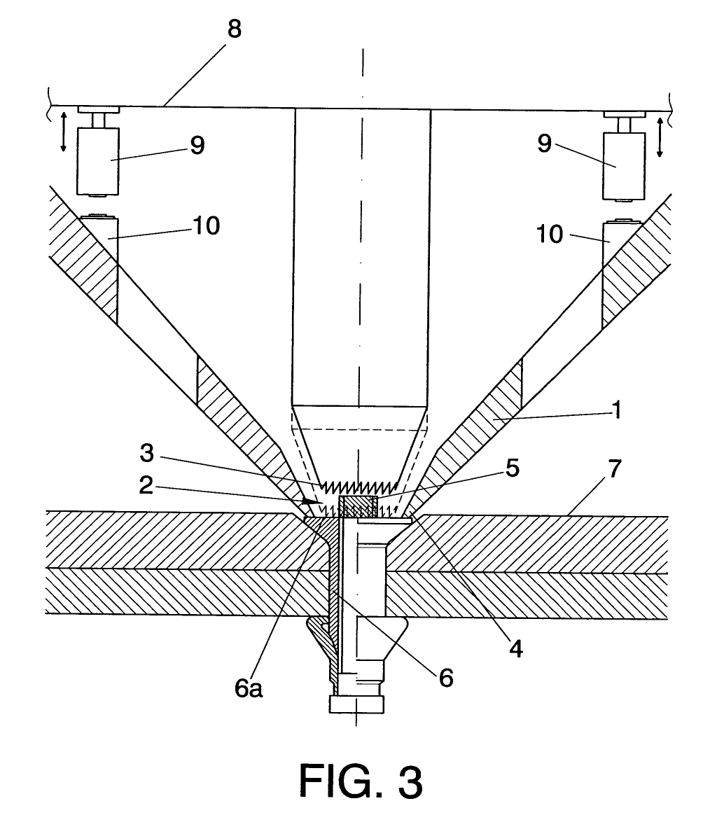

In this movement, the milling machine 3 starts to trim the stem 5, in such manner that at the same time the micro-switches 9 descend until they make contact with the limits 10, triggering a signal for withdrawal of the headstock which is picked up by the robot, in such a way that the stem 5 is trimmed to the same depth as the separation existing between the micro-switches 9 and the limits 10. Given that for each rivet the trimming is carried out with the mouth 4 resting on the surface 6a of the head of the rivet, so the depth of trimming is always the same for all the rivets made on the surface 7, and all this is independent of the depth at which the rivet is to be found, as can be seen from FIGS. 2 and 3 in which the surface 6a of the head of the rivet 6 sits at a lower level with respect to the surface 7, and as can be seen from FIG. 3 in which the surface 6a of the head of the rivet 6 sits at a higher level than the surface 7.

The invention provides that the separation between the micro-switches 9 and 10 can be adjusted according to different rivets that can be made by different robots, in such a way that the headstock can adapt itself to any robot.

Once the withdrawal of the headstock has taken place, in the manner already described, the casing 1 returns to its relative position with respect to the support 8 and milling machine 3, due to the action of the springs already mentioned, with the headstock being ready to effect a new trimming of a stem 5 of another rivet 6.

1. MILLING HEADSTOCK FOR RIVET STEMS, comprising a mouth (4) for the introduction of the surplus stem (5) of a rivet (6), and in front of which it includes a milling machine (3) that can be displaced a previously established length towards the mouth (4), in order to trim the stem (5) of the different rivets (6) made in a piece; characterised in that the mouth (4) has a dimension selected between a dimension equal to the dimension of the surface (6a) of the head of the rivet (6) and a dimension less than the dimension of the surface (6a) of the head of the rivet (6), so that the mouth (4) rests on the surface (6a) of said head of the rivet (6) and at all times the same amount of stem (5) is left in each rivet made, being kept within the established margins of tolerance independently of the depth at which each rivet (6) is fixed in the piece.

2. MILLING HEADSTOCK FOR RIVET STEMS, according to claim 1, characterised in that the milling machine (3) is arranged in a fixed position inside the headstock, and the mouth (4) is arranged in an external casing (1) that can be displaced with respect to the milling machine (3) and assisted by at least one spring, so that, when the mouth (4) presses on the surface of the rivet (6), overcoming the action of at least one spring, the casing (1) is displaced with respect to the milling machine (3) causing the latter to advance.

3. MILLING HEADSTOCK FOR RIVET STEMS, according claim 1, characterised in that the headstock is mounted on a robot provided with means of positioning the headstock facing the surface (6a) of the head of the rivet (6), and means of advance so that it presses against said surface (6a) of the head of the rivet (6).

4. MILLING HEADSTOCK FOR RIVET STEMS, according to claim 1, characterised in that the milling machine (3) is arranged in a support (8) provided with at least one micro-switch (9) which, when it makes contact with a limit (10) of the casing (1), is detected by the robot performing the withdrawal of the headstock and locating the casing (1) in its initial position due to the action of the spring.

5. MILLING HEADSTOCK FOR RIVET STEMS, according to claim 4, characterised in that the relative position of the limit (10) with respect to at least one micro-switch (9) is adjustable according to the length of the surplus stem (5).

6. MILLING HEADSTOCK FOR RIVET STEMS, according to claim 2, characterised in that the headstock is mounted on a robot provided with means of positioning the headstock facing the surface (6a) of the head of the rivet (6), and means of advance so that it presses against said surface (6a) of the head of the rivet (6).

7. MILLING HEADSTOCK FOR RIVET STEMS, according to claim 3, characterised in that the milling machine (3) is arranged in a support (8) provided with at least one micro-switch (9) which, when it makes contact with a limit (10) of the casing (1), is detected by the robot performing the withdrawal of the headstock and locating the casing (1) in its initial position due to the action of the spring.
